(19) United States
(12) Patent Application Publication
(10) Pub. No.: US 2016/0104498 A1
(43) Pub. Date: Apr. 14, 2016

(54) APPARATUS AND METHOD FOR TRANSMITTING WATERMARK ROBUST TO ACOUSTIC CHANNEL DISTORTION

(71) Applicant: Electronics and Telecommunications Research Institute, Daejeon (KR)

(72) Inventors: Seung Kwon BEACK, Seoul (KR); Tae Jin PARK, Daejeon (KR); Jong Mo SUNG, Daejeon (KR); Yong Ju LEE, Daejeon (KR); Tae Jin LEE, Daejeon (KR); Kyeong Ok KANG, Daejeon (KR)

(21) Appl. No.: 14/881,375

(22) Filed: Oct. 13, 2015

(30) Foreign Application Priority Data
Oct. 13, 2014 (KR) 10-2014-0137378

(51) Int. Cl. G10L 19/018

(52) U.S. Cl. CPC G10L 19/018

(57) ABSTRACT

A method and an apparatus for transmitting a watermark robust to an acoustic channel distortion are disclosed. The method of transmitting the watermark may include extracting a watermark from a first audio signal including the watermark; modifying the extracted watermark based on a state of an acoustic channel; and embedding the modified watermark into the first audio signal to output a second audio signal.

### CROSS-REFERENCE TO RELATED APPLICATION

This application claims the priority benefit of Korean Patent Application No. 10-2014-0137378, filed on Oct. 13, 2014, in the Korean Intellectual Property Office, the disclosure of which is incorporated herein by reference.

### BACKGROUND

1. Field of the Invention

Embodiments of the present invention relate to an apparatus and a method for transmitting a watermark, and more particularly, to an apparatus and a method for transmitting a watermark which minimize errors by acoustic channel distortion.

2. Description of the Related Art

Audio watermarking is a technique of embedding additional information into an audio signal to output the audio signal so that a terminal collecting the audio signal using a microphone extracts the additional information from the audio signal. Here, the additional information embedded in the audio signal secures minimized loss of audio quality and is used to identify copyright of the original audio signal.

According to audio watermarking techniques, however, the additional information is transmitted to the terminal through the audio signal output via a speaker, and thus the audio signal may be distorted depending on a state of an acoustic channel through which the audio signal output via the speaker pass until collected with the microphone. Signals collected with the microphone of the terminal may include, for example, the audio signal output via the speaker, noises, and impulses due to the audio signal.

The terminal extracts the additional information from the signals including not only the audio signal output via the speaker but the noises and pulses, and thus bit errors may occur by the noises and impulses, as compared with the original additional information.

Thus, when additional information is transmitted using audio watermarking techniques, a method for minimizing bit error ratio (BER) caused by a distortion in an acoustic channel is required.

### SUMMARY

An aspect of the present invention provides an apparatus and a method of transmitting a watermark which minimize errors, that is, bit error ratio, caused by an acoustic channel distortion.

According to an aspect of the present invention, there is provided a method of transmitting a watermark, the method including: extracting a watermark from a first audio signal including the watermark; modifying the extracted watermark based on a state of an acoustic channel; and embedding the modified watermark into the first audio signal to output a second audio signal.

The method may further include determining an analysis parameter by analyzing the state of the acoustic signal measured with a microphone, wherein the modifying of the watermark may amplify the watermark based on the determined analysis parameter.

The determining of the analysis parameter may predict a noise and an impulse generated by output of the second audio signal based on the measured state of the acoustic channel, and determine a gain by the noise and a gain by the impulse based on a prediction result.

The state of the acoustic channel may include at least one of a noise and an impulse generated by the second audio signal output at a previous time before measurement with the microphone.

According to another aspect of the present invention, there is provided a method of transmitting a watermark, the method including: decoding a watermark and a first audio signal from a bitstream; modifying the decoded watermark based on a state of an acoustic channel; and embedding the modified watermark into the first audio signal to output a second audio signal.

The method may further include determining an analysis parameter by analyzing the state of the acoustic signal measured with a microphone, wherein the modifying of the watermark may amplify the watermark based on the determined analysis parameter.

The determining of the analysis parameter may predict a noise and an impulse generated by output of the second audio signal based on the measured state of the acoustic channel, and determine a gain by the noise and a gain by the impulse based on a prediction result.

The bitstream may be configured by comprising a watermark bitstream obtained by converting additional information into a bitstream in an ancillary area of an audio bitstream obtained by converting the first audio signal into a bitstream.

The bitstream may be configured by combining a watermark bitstream obtained by converting additional information into a bitstream with an audio bitstream obtained by converting the first audio signal into a bitstream as additional information.

According to still another aspect of the present invention, there is provided an apparatus for transmitting a watermark, the apparatus including: a watermark decoder to extract a watermark from a first audio signal including the watermark; and a watermark encoder to modify the extracted watermark based on a state of an acoustic channel, and to embed the modified watermark into the first audio signal to output a second audio signal.

According to still another aspect of the present invention, there is provided an apparatus for transmitting a watermark, the apparatus including: an audio decoder to decode a first audio signal from a bitstream; an additional information decoder to decode a watermark from the bitstream; and a watermark encoder to modify the decoded watermark based on a state of an acoustic channel, and to embed the modified watermark into the first audio signal to output a second audio signal.

According to an aspect of the present invention, a watermark is extracted from a received audio signal and the extracted watermark is amplified according to an acoustic channel state and embedded back into the audio signal, thereby minimizing errors by an acoustic channel distortion in a watermark transmitting process.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a watermark transmission system according to an embodiment of the present invention;

FIG. 2 illustrates a watermark embedding apparatus according to an embodiment of the present invention;

FIG. 3 illustrates a watermark embedding apparatus according to a first embodiment of the present invention;

FIG. 4 illustrates a watermark embedding apparatus according to a second embodiment of the present invention;

FIG. 5 illustrates a watermark embedding apparatus according to a third embodiment of the present invention;

FIG. 6 illustrates a watermark transmission apparatus according to an embodiment of the present invention;

FIG. 7 illustrates a watermark transmission apparatus according to a first embodiment of the present invention;

FIG. 8 illustrates a watermark transmission apparatus according to a second embodiment of the present invention;

FIG. 9 illustrates a watermark transmission apparatus according to a third embodiment of the present invention;

FIG. 10 is a flowchart illustrating operations of a watermark transmission system according to an embodiment of the present invention;

FIG. 11 is a flowchart illustrating a watermark transmission method according to a first embodiment of the present invention;

FIG. 12 is a flowchart illustrating a watermark transmission method according to a second embodiment of the present invention; and

FIG. 13 is a flowchart illustrating a watermark transmission method according to a third embodiment of the present invention.

### DETAILED DESCRIPTION

Hereinafter, exemplary embodiments of the present invention will be described in detail with reference to the accompanying drawings. A method of transmitting a watermark (hereinafter “watermark transmission method”) according to an exemplary embodiment may be performed by an apparatus for transmitting a watermark (hereinafter “watermark transmission apparatus”) included in a watermark transmission system.

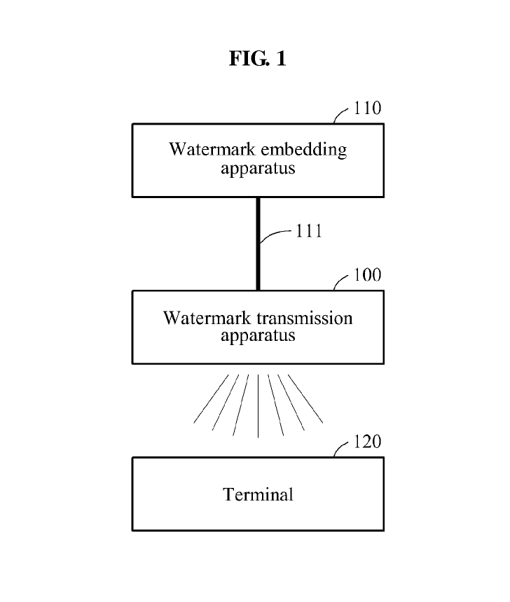

FIG. 1 illustrates a watermark transmission system according to an embodiment of the present invention.

Referring to FIG. 1, the watermark transmission system according to the present embodiment may include a watermark embedding apparatus 110 and a watermark transmission apparatus 100.

The watermark embedding apparatus 110 may transmit an original audio signal and a watermark together to the watermark transmission apparatus 100. Here, the watermark embedding apparatus 110 may embed the watermark into the original audio signal for transmission. Alternatively, the watermark embedding apparatus 110 may embed an additional information encoding bitstream obtained by encoding the watermark into an audio bitstream obtained by encoding the original audio signal for transmission. The watermark embedding apparatus 110 may transmit the additional information encoding bitstream as additional information.

The watermark embedding apparatus 110 may transmit the original audio signal and the watermark to the watermark transmission apparatus 100 through a broadcast transmission path 111, thereby preventing the original audio signal and the watermark from being distorted during transmission.

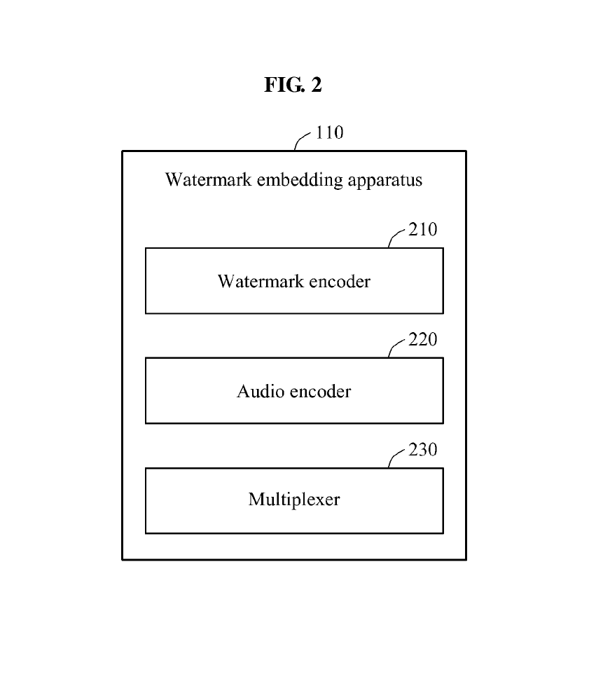

A detailed configuration and operations of the watermark embedding apparatus 110 will be described in detail with reference to FIGS. 2 to 5.

The watermark transmission apparatus 100 may output the audio signal including the watermark through a speaker to transmit the watermark to a terminal 120. Here, the terminal 120 may collect the audio signal through a microphone, and extract and decode the watermark from the collected audio signal. However, the audio signal output from the watermark transmission apparatus 100 may have an acoustic channel distortion depending on an acoustic channel state. Thus, the watermark decoded by the terminal 120 may be different from the watermark embedded by the watermark embedding apparatus 110. Here, the acoustic channel state may include at least one of a noise in a space where the terminal 120 is positioned and an impulse of the audio signal.

The watermark transmission apparatus 100 may embed a watermark modified based on the acoustic channel state into the audio signal to output the audio signal, thereby transmitting the watermark robust to the acoustic channel distortion to the terminal 120.

In detail, the watermark transmission apparatus 100 may extract the watermark from the audio signal received from the watermark embedding apparatus 110. Here, the audio signal received by the watermark transmission apparatus 100 from the watermark embedding apparatus 110 is transmitted through the broadcast transmission path 111 and thus may not have an acoustic channel distortion.

Next, the watermark transmission apparatus 100 may modify the extracted watermark based on the acoustic channel state and embed the modified watermark into the audio signal. Here, the watermark transmission apparatus 100 may estimate attenuation information on the audio signal based on an acoustic channel by analyzing the acoustic channel state and amplify the watermark considering an estimation result. Here, as the audio signal with the embedded watermark attenuates according to the acoustic channel, the amplified watermark may also attenuate. However, since the watermark is amplified, the watermark even in an attenuated state may be maintained at least in the same condition as that of the watermark extracted by the watermark transmission apparatus 100. Thus, the terminal 120 may extract the amplified watermark to decode the watermark having no bit error by the acoustic channel distortion.

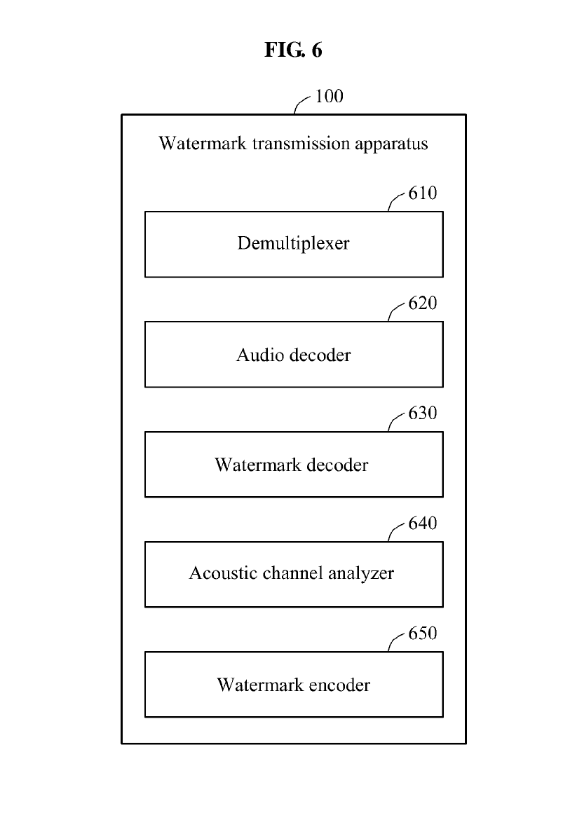

A detailed configuration and operations of the watermark transmission apparatus 100 will be described in detail with reference to FIGS. 6 to 9.

FIG. 2 illustrates a watermark embedding apparatus according to an embodiment of the present invention.

Referring to FIG. 2, the watermark embedding apparatus 110 according to the present embodiment may include a watermark encoder 210, an audio encoder 220, and a multiplexer 230.

The watermark encoder 210 may embed additional information into original audio information using a watermarking technique to generate a first audio signal. Here, the watermark encoder 210 may embed the additional information as a watermark without considering an acoustic channel distortion. That is, the watermark encoder 210 may embed the additional information into the original audio information as the watermark audibly unrecognizable by a user using a conventional watermarking technique.

The audio encoder 220 may encode the first audio signal generated by the watermark encoder 210 to output an audio bitstream.

The multiplexer 230 may multiplex the audio bitstream output from the audio encoder 220 and transmit the audio bitstream to the watermark transmission apparatus 110. Here, the multiplexer 230 may multiplex the audio bitstream to be combined with other pieces of information of bit strings to be transmitted to the watermark transmission apparatus 110. The multiplexer 230 may process the audio bitstream combined with the bit strings for information transmission and transmit the audio bitstream to the watermark transmission apparatus 110 through a broadcast transmission path 111. For instance, the multiplexer 230 may perform at least one of packaging and channel coding on the audio bitstream combined with the bit strings.

The watermark embedding apparatus 110 may also transmit the additional information to the watermark transmission apparatus 110 without embedding the additional information into the audio information. For example, the watermark embedding apparatus 110 may input an additional information bitstream, obtained by converting the additional information into a bitstream, to the audio encoder 220 or the multiplexer 230.

When the additional information bitstream is input to the audio encoder 220, the audio encoder 220 may include the input additional information bitstream in an ancillary area of the audio bitstream.

When the additional information bitstream is input to the multiplexer 230, the multiplexer 230 may combine the additional information bitstream with the audio bitstream as additional information.

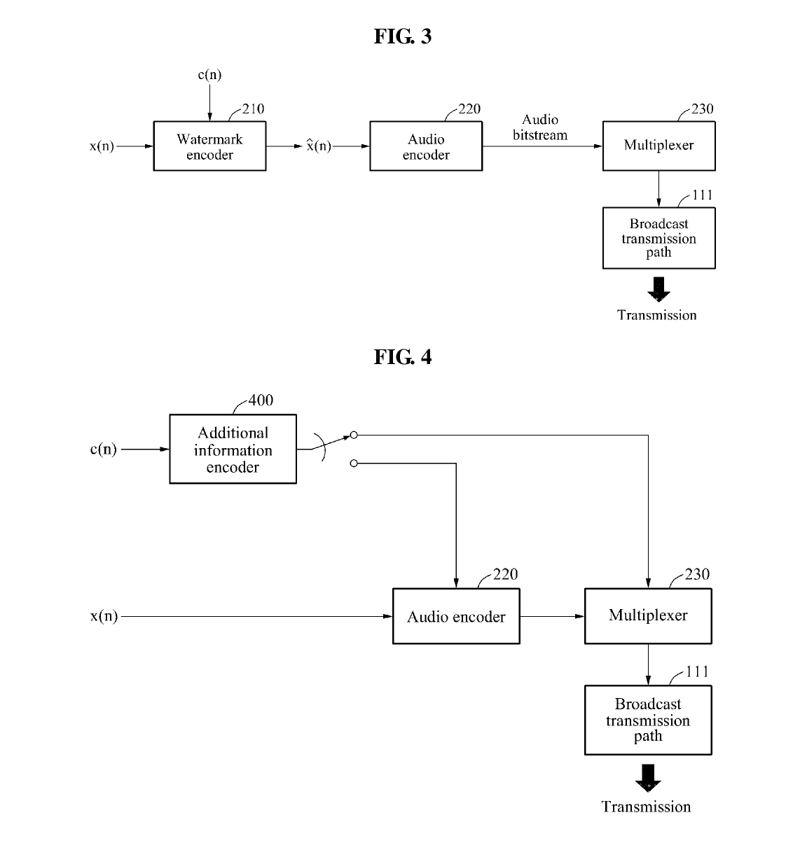

FIG. 3 illustrates a watermark embedding apparatus according to a first embodiment of the present invention.

First, as shown in FIG. 3, a watermark encoder 210 may embed additional information c(n) into original audio information x(n) to output a first audio signal \hat{x}(n).

Next, an audio encoder 220 may convert the first audio signal \hat{x}(n) into a bitstream to output an audio bitstream.

Finally, a multiplexer 230 may multiplex the audio bitstream to be combined with other pieces of information of bit strings to be transmitted to a watermark transmission apparatus 110. The multiplexer 230 may process the audio bitstream combined with the bit strings for information transmission and transmit the audio bitstream to the watermark transmission apparatus 110 through a broadcast transmission path 111.

FIG. 4 illustrates a watermark embedding apparatus according to a second embodiment of the present invention.

FIG. 4 illustrates that the watermark embedding apparatus 110 transmits additional information to a watermark transmission apparatus 110 without embedding the additional information into audio information.

When the watermark embedding apparatus 110 transmits additional information to the watermark transmission apparatus 110 without embedding the additional information into audio information, the watermark embedding apparatus 110 may further include an additional information encoder 440 as shown in FIG. 4.

First, the additional information encoder 400 may encode additional information c(n) to output an additional information bitstream. For example, when the additional information c(n) is text information, the additional information encoder 400 may encode the additional information using a text compression technique to output an additional information bitstream. When the additional information c(n) is a time code, the additional information encoder 400 may encode the additional information using a method of converting a numerical value into a bit string to output an additional information bitstream. When the additional information c(n) is a channel identifier (ID), the additional information encoder 400 may form channel values corresponding to channel IDs into a table and represents an index of the table as a bit string to output an additional information bitstream.

The additional information encoder 400 may transmit the additional information bitstream to an audio encoder 220 or a multiplexer 230.

When the additional information encoder 400 transmits the additional information bitstream to the audio encoder 220, the audio encoder 220 may include the additional information bitstream in an ancillary area of an audio bitstream.

When the additional information encoder 400 transmits the additional information bitstream to the multiplexer 230, the multiplexer 230 may combine the additional information bitstream with the audio bitstream as additional information. The multiplexer 230 may transmit the additional information bitstream to the watermark transmission apparatus 100 as separate bit information from the audio bitstream.

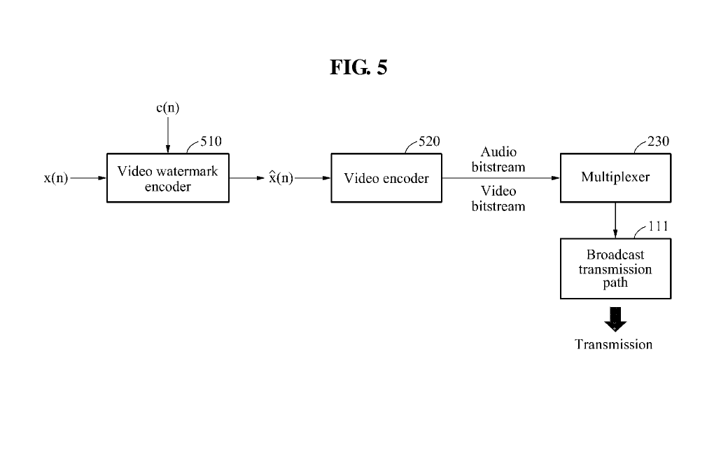

FIG. 5 illustrates a watermark embedding apparatus according to a third embodiment of the present invention.

FIG. 5 shows the watermark embedding apparatus 110 which embeds an audio watermark in a watermark transmission apparatus 100 using a video watermarking technique.

First, as illustrated in FIG. 5, a video watermark encoder 510 may embed additional information c(n) as a watermark into original video information x(n) to output a first video signal \hat{x}(n).

Next, a video encoder 520 may convert the first video signal \hat{x}(n) into a bitstream to output an audio bitstream and a video bitstream.

Finally, a multiplexer 230 may multiplex the audio bitstream and the video bitstream to be combined with other pieces of information of bit strings to be transmitted to the watermark transmission apparatus 100. The multiplexer 230 may process the audio bitstream and the video bitstream combined with the bit strings for information transmission and transmit the audio bitstream and the video bitstream to the watermark transmission apparatus 100 through a broadcast transmission path 111.

FIG. 6 illustrates a watermark transmission apparatus according to an embodiment of the present invention.

Referring to FIG. 6, the watermark transmission apparatus 100 according to the present embodiment may include a demultiplexer 610, an audio decoder 620, a watermark decoder 630, an acoustic channel analyzer 640 and a watermark encoder 650.

The demultiplexer 610 may demultiplex information received through a broadcast transmission path 111 to decode an audio bitstream. Here, the demultiplexer 610 may be a decoder corresponding to the multiplexer 230 of the watermark embedding apparatus 110.

The audio decoder 620 may convert the audio bitstream decoded by the demultiplexer 610 into a first audio signal including a watermark to output the first audio signal. Here, the audio decoder 620 may be a decoder corresponding to the audio encoder 220 of the watermark embedding apparatus 110.

The watermark decoder 630 may extract the watermark from the first audio signal output by the audio decoder 620. Here, the watermark decoder 630 may be a decoder corresponding to the watermark encoder 210 of the watermark embedding apparatus 100.

The acoustic channel analyzer 640 may analyze a state of an acoustic channel measured with a microphone to determine an analysis parameter. Here, the state of the acoustic channel may include at least one of a noise and an impulse generated according to a second audio signal output at a previous time before measurement with the microphone. For example, when a current time is t, the state of the acoustic channel may include at least one of a noise and an impulse generated due to the second audio signal output at t−1.

Here, the acoustic channel analyzer 640 may predict the noise and the impulse generated by output of the second audio signal on the basis of the state of the acoustic channel measured with the microphone and determine a gain by the noise and a gain by the impulse based on a prediction result.

When the watermark transmission apparatus 100 has no microphone for measuring the state of the acoustic channel, the acoustic channel analyzer 640 may output a predetermined analysis parameter. Here, the analysis parameter output from the acoustic channel analyzer 640 may be an analysis parameter determined by measuring the state of the acoustic channel in a space with a structure the same as or similar to that of a room where the watermark transmission apparatus 100 is installed.

The watermark encoder 650 may modify the watermark extracted by the watermark decoder 630 according to the state of the acoustic channel. Here, the watermark encoder 650 may amplify the watermark according to the analysis parameter determined by the acoustic channel analyzer 640.

The watermark encoder 650 may embed the modified watermark into the first audio signal output by the audio decoder 620 to output a second audio signal.

When the watermark embedding apparatus 110 transmits additional information to the watermark transmission apparatus 100 without embedding the additional information into audio information, the watermark transmission apparatus 100 may further include an additional information decoder. Here, the demultiplexer 610 may decode an additional information bitstream combined with the audio bitstream as additional information from the received information and transmit the additional information bitstream to the additional information decoder. Alternatively, the audio decoder 620 may decode the additional information bitstream included in an ancillary area of the audio bitstream and transmit the additional information bitstream to the additional information decoder. The additional information decoder may decode the additional information bitstream into a watermark and transmit the watermark to the watermark encoder 650.

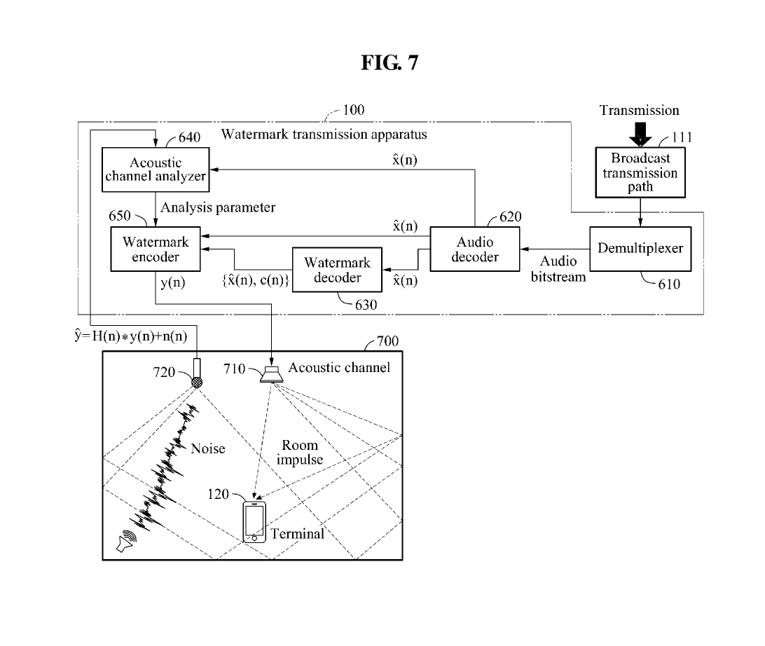

FIG. 7 illustrates a watermark transmission apparatus according to a first embodiment of the present invention.

First, a demultiplexer 610 may demultiplex information received through a broadcast transmission path 111 to decode an audio bitstream.

Next, an audio decoder 620 may convert the audio bitstream, decoded by the demultiplexer 610, into a first audio signal \hat{x}(n) a watermark c(n) to output the first audio signal.

A watermark decoder 630 may extract the watermark c(n) from the first audio signal output by the audio decoder 620. In addition, as shown in FIG. 7, the watermark decoder 630 may transmit the extracted watermark c(n) and first audio signal \hat{x}(n) to a watermark encoder 650.

An acoustic channel analyzer 640 may analyze a state of an acoustic channel measured with a microphone 720 to determine an analysis parameter. Here, the state of the acoustic channel may include at least one of a noise and an impulse generated due to a second audio signal output at a previous time through a speaker 710 to a space 700 where a terminal 120 is positioned before measurement with the microphone 720. Here, the room 700 may be one of a room and an inside of a building.

In detail, the acoustic channel analyzer 640 may predict a signal-to-noise ratio (SNR) and reverberation time of the acoustic channel generated by output of the second audio signal on the basis of the state of the acoustic channel measured with the microphone 720.

Here, the acoustic channel analyzer 640 may represent the state ŷ of the acoustic channel measured with the microphone 720 as Equation 1.

ŷ=H(n)*y(n)+n(n) [Equation 1]

Here, n(n) may be a noise generated due to a second audio signal y(n) output at time t−1, and H(n) may be an impulse generated due to the second audio signal y(n) output at time t−1. Accordingly, the acoustic channel analyzer 640 may acquire the noise n(n) at t−1 and the impulse H(n) at t−1 in the state ŷ of the acoustic channel. Also, the acoustic channel analyzer 640 may predict a noise n(n) at time t and an impulse H(n) at time t generated due to a second audio signal y(n) output at time t on the basis of the noise n(n) at t−1, the impulse H(n) at t−1 and the first audio signal \hat{x}(n). Here, the acoustic channel analyzer 640 may determine a gain by the noise and a gain by the impulse on the basis of a prediction result. The acoustic channel analyzer 640 may repeat the foregoing process to determine and output the gain by the noise and the gain by the impulse as analysis parameters.

Finally, the watermark encoder 650 may modify the watermark c(n) extracted by the watermark decoder 630 based on the state of the acoustic channel. Here, the watermark encoder 650 may amplify the watermark according to the analysis parameters determined by the acoustic channel analyzer 640.

The watermark encoder 650 may embed the modified watermark c(n) into the first audio signal \hat{x}(n) output from the audio decoder 620, to output a second audio signal y(n). For example, the watermark encoder 650 may output the second audio signal y(n) using Equation 2.

y(n)=watermark_enc2(\hat{x}(n),γₚₐₘρ_{SNR}ρ_{RT}c(n)) [Equation 2]

Here, ρ_{SNR} may be a gain by an SNR of an acoustic signal, and ρ_{RT} may be a gain by an impulse. That is, the watermark encoder 650 may embed the watermark c(n), modified in consideration of the gain by the noise and the gain by the impulse, into the first audio signal \hat{x}(n) to output the second audio signal y(n).

In addition, Watermark_enc2 may be a random watermark encoding function, and coefficient γₚₐₘ may be a gain value securing a minimum recognizable sound quality distortion. Here, γₚₐₘ may be determined using a psychoacoustic model.

The second audio signal y(n) output from the watermark encoder 650 includes the watermark c(n) which may be amplified based on a distortion of the acoustic channel and be embedded. Thus, even though a distortion occurs by a noise or impulse while the terminal 120 is collecting the second audio signal y(n) output from a speaker 710, the watermark c(n) may maintain a sufficient intensity so that the terminal 120 extracts the watermark. That is, although a distortion occurs by the acoustic channel in the space 700, the terminal 120 may extract the watermark c(n) without errors.

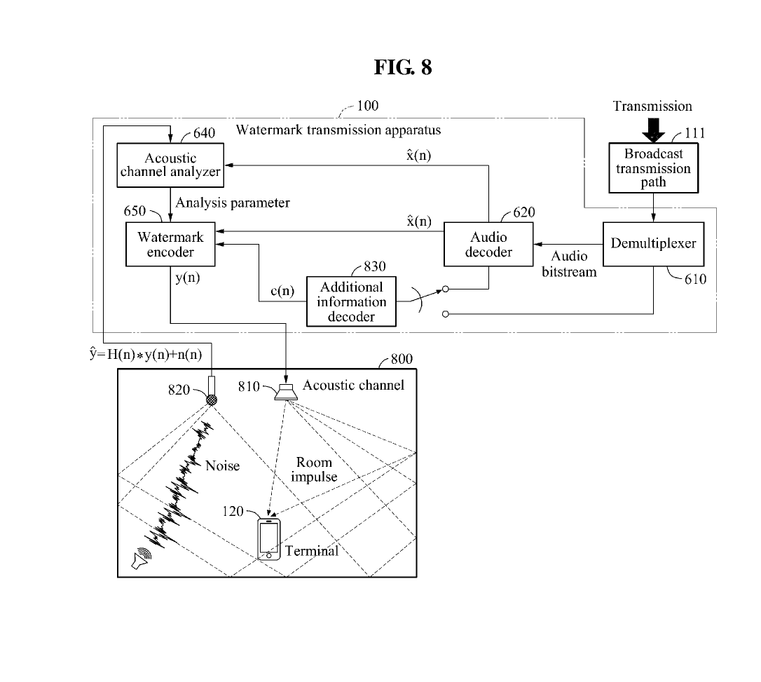

FIG. 8 illustrates a watermark transmission apparatus according to a second embodiment of the present invention.

FIG. 8 illustrates the watermark transmission apparatus 100 which receives additional information not embedded into audio information when a watermark embedding apparatus 110 transmits the additional information to the watermark transmission apparatus 100 without embedding the additional information into the audio information.

First, a demultiplexer 610 may demultiplex information received through a broadcast transmission path 111 to decode an audio bitstream.

When the watermark embedding apparatus 110 transmits an additional information bitstream combined with the audio bitstream as additional information, the demultiplexer 610 may separate the additional information bitstream combined with the audio bitstream and transmit the additional information bitstream to an additional information decoder 830.

Further, when the watermark embedding apparatus 110 includes the additional information bitstream in an ancillary area of the audio bitstream, the demultiplexer 610 may transmit the audio bitstream including the additional information bitstream in the ancillary area to an audio decoder 620.

Next, the audio decoder 620 may convert the audio bitstream decoded by the demultiplexer 610 into a first audio signal including a watermark c(n) and output the first audio signal. When the watermark embedding apparatus 110 includes the additional information bitstream in the ancillary area of the audio bitstream, the audio decoder 620 may separate the additional information bitstream included in the ancillary area of the audio bitstream and transmit the additional information bitstream to the additional information decoder 830.

Here, the additional information decoder 830 may convert the additional information bitstream received from the demultiplexer 610 or the audio decoder 620 into the watermark c(n) and output the watermark.

Subsequently, an acoustic channel analyzer 640 may analyze a state of an acoustic channel measured with a microphone 820 to determine an analysis parameter. Here, the state of the acoustic channel may include at least one of a noise and an impulse generated due to a second audio signal output at a previous time through a speaker 810 to a space 800 where a terminal 120 is positioned before measurement with the microphone 820. In detail, the acoustic channel analyzer 640 may predict an SNR and reverberation time of the acoustic channel generated by output of the second audio signal on the basis of the state of the acoustic channel measured with the microphone 820. In addition, the acoustic channel analyzer 640 may determine a gain by the noise and a gain by the impulse on the basis of a prediction result. The acoustic channel analyzer 640 may repeat the foregoing process to determine and output the gain by the noise and the gain by the impulse as analysis parameters.

Finally, a watermark encoder 650 may modify the watermark c(n) output from the additional information decoder 830 based on the state of the acoustic channel Here, the watermark encoder 650 may amplify the watermark according to the analysis parameters determined by the acoustic channel analyzer 640.

The watermark encoder 650 may embed the modified watermark c(n) into the first audio signal \hat{x}(n) output from the audio decoder 620 to output the second audio signal y(n).

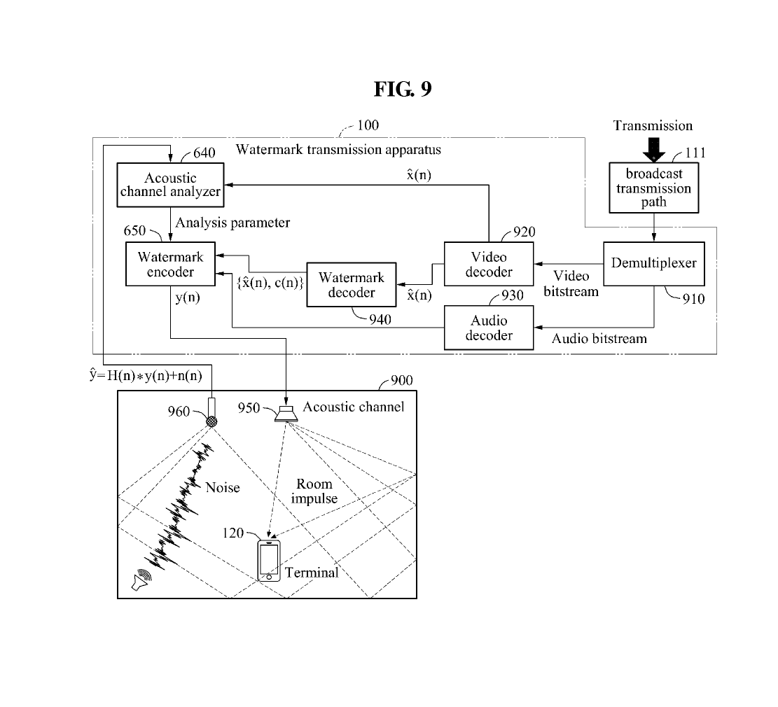

FIG. 9 illustrates a watermark transmission apparatus according to a third embodiment of the present invention.

FIG. 9 illustrates the watermark transmission apparatus 100 which embeds an audio watermark using a video watermarking technique.

First, a demultiplexer 910 may demultiplex information received through a broadcast transmission path 111 to decode a video bitstream and an audio bitstream.

The demultiplexer 910 may transmit the video bitstream to a video decoder 920 and transmit the audio bitstream to an audio decoder 930.

The video decoder 920 may convert the video bitstream, decoded by the demultiplexer 910, into a first video signal \hat{x}(n) including a watermark c(n) and output the first video signal. The audio decoder 930 may convert the audio bitstream, decoded by the demultiplexer 910, into an audio signal and transmit the audio signal to a watermark encoder 650.

Here, a watermark decoder 940 may extract the watermark c(n) from the first video signal \hat{x}(n) received from the video decoder 920 and transmit the watermark c(n) to the watermark encoder 650.

Subsequently, an acoustic channel analyzer 640 may analyze a state of an acoustic channel measured with a microphone 960 to determine an analysis parameter. Here, the state of the acoustic channel may include at least one of a noise and an impulse generated due to a second audio signal output at a previous time through a speaker 950 to a space 900 where a terminal 120 is positioned before measurement with the microphone 960. In detail, the acoustic channel analyzer 640 may predict an SNR and reverberation time of the acoustic channel generated by output of the second audio signal on the basis of the state of the acoustic channel measured with the microphone 960. In addition, the acoustic channel analyzer 640 may determine a gain by the noise and a gain by the impulse on the basis of a prediction result. The acoustic channel analyzer 640 may repeat the foregoing process to determine and output the gain by the noise and the gain by the impulse as analysis parameters.

Finally, the watermark encoder 650 may modify the watermark c(n) transmitted from the watermark decoder 940 based on the state of the acoustic channel. Here, the watermark encoder 650 may amplify the watermark according to the analysis parameters determined by the acoustic channel analyzer 640.

The watermark encoder 650 may embed the modified watermark c(n) into the audio signal transmitted from the audio decoder 930 to output a second audio signal y(n).

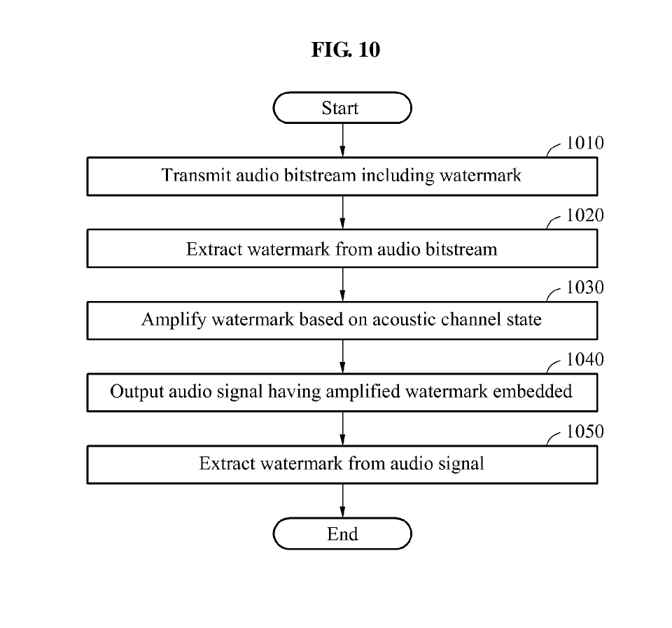

FIG. 10 is a flowchart illustrating operations of a watermark transmission system according to an embodiment of the present invention.

In operation 1010, a watermark embedding apparatus 110 may transmit an original audio signal and a watermark together to a watermark transmission apparatus 100. Here, the watermark embedding apparatus 110 may embed the watermark into the original audio signal for transmission. Alternatively, the watermark embedding apparatus 110 may embed an additional information encoding bitstream obtained by encoding the watermark into an audio bitstream obtained by encoding the original audio signal for transmission. The watermark embedding apparatus 110 may transmit the additional information encoding bitstream as additional information.

In operation 1020, the watermark transmission apparatus 100 may extract the watermark from the audio signal received in operation 1010. Here, the audio signal received by the watermark transmission apparatus 100 from the watermark embedding apparatus 110 is transmitted through a broadcast transmission path 111 and thus may not have an acoustic channel distortion.

In operation 1030, the watermark transmission apparatus 100 may amplify the watermark extracted in operation 1020 based on an acoustic channel state.

In operation 1040, the watermark transmission apparatus 100 may embed the watermark amplified in operation 1030 into the audio signal and output the audio signal to a speaker.

In operation 1050, a terminal 120 may receive the audio signal output in operation 1040 using a microphone. The terminal 120 may extract the watermark from the received audio signal.

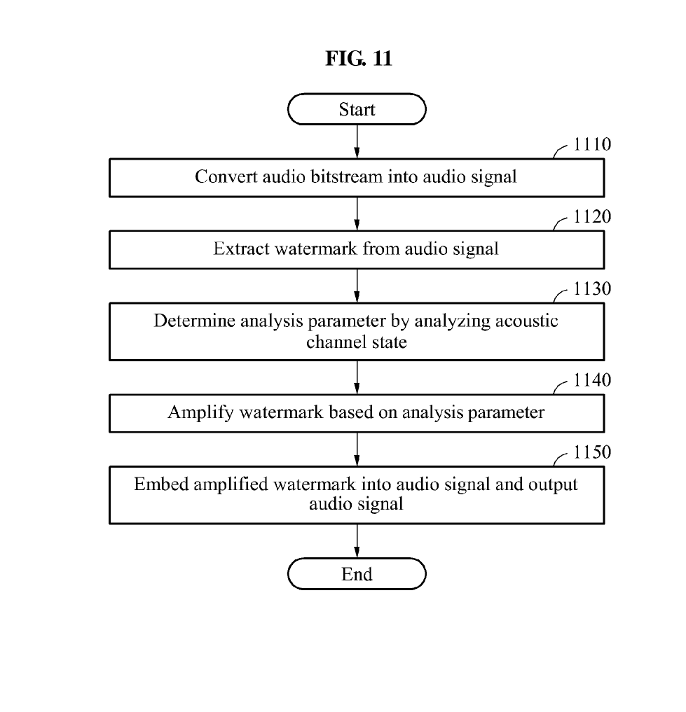

FIG. 11 is a flowchart illustrating a watermark transmission method according to a first embodiment of the present invention.

FIG. 11 is the flowchart illustrating the watermark transmission method performed by a watermark transmission apparatus when a watermark embedding apparatus 110 embeds a watermark into an original audio signal and transmits the audio signal.

In operation 1110, a demultiplexer 610 may demultiplex information received through a broadcast transmission path 111 to decode an audio bitstream. An audio decoder 620 may convert the audio bitstream, decoded by the demultiplexer 610, into a first audio signal including a watermark to output the first audio signal.

In operation 1120, a watermark decoder 630 may extract the watermark from the first audio signal output in operation 1110.

In operation 1130, an acoustic channel analyzer 640 may analyze a state of an acoustic channel measured with a microphone to determine an analysis parameter. Here, the acoustic channel analyzer 640 may predict a noise and an impulse generated by output of a second audio signal on the basis of the state of the acoustic channel measured with the microphone, and determine a gain by the noise and a gain by the impulse on the basis of a prediction result.

In operation 1140, a watermark encoder 650 may amplify the watermark according to the analysis parameters determined in operation 1130.

In operation 1150, the watermark encoder 650 may embed the watermark amplified in operation 1140 into the first audio signal output in operation 1110 to output the second audio signal.

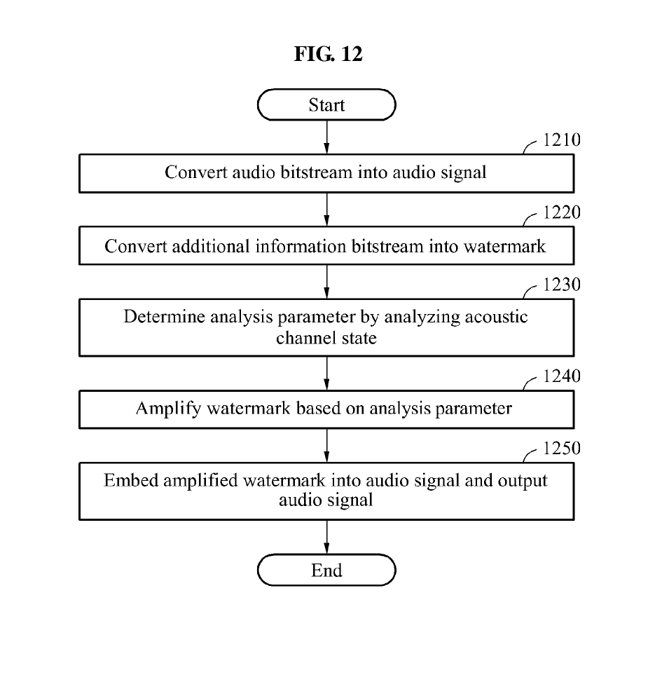

FIG. 12 is a flowchart illustrating a watermark transmission method according to a second embodiment of the present invention.

FIG. 12 is the flowchart illustrating the watermark transmission method performed by a watermark transmission apparatus when a watermark embedding apparatus 110 embeds an additional information encoding bitstream obtained by encoding a watermark into an audio bitstream to transmit the audio bitstream or transmits the additional information encoding bitstream as additional information of the audio bitstream.

In operation 1210, a demultiplexer 610 may demultiplex information received through a broadcast transmission path 111 to decode an audio bitstream. When the watermark embedding apparatus 110 transmits the additional information bitstream combined with the audio bitstream as the additional information, the demultiplexer 610 may separate the additional information bitstream from the audio bitstream and transmit the additional information bitstream to an additional information decoder 830. In addition, when the watermark embedding apparatus 110 includes the additional information bitstream in an ancillary area of the audio bitstream, the demultiplexer 610 may transmit the audio bitstream including the additional information bitstream in the ancillary area to an audio decoder 620.

The audio decoder 620 may convert the audio bitstream decoded by the demultiplexer 610 into a first audio signal including a watermark to output the first audio signal. When the watermark embedding apparatus 110 includes the additional information bitstream in the ancillary area of the audio bitstream, the audio decoder 620 may separate the additional information bitstream included in the ancillary area of the audio bitstream and transmit the additional information bitstream to the additional information decoder 830.

In operation 1220, the additional information decoder 830 may convert the additional information bitstream received in operation 1210 into the watermark and output the watermark.

In operation 1230, an acoustic channel analyzer 640 may analyze a state of an acoustic channel measured with a microphone to determine an analysis parameter. In detail, the acoustic channel analyzer 640 may predict an SNR and reverberation time of the acoustic channel generated by output of a second audio signal on the basis of the state of the acoustic channel measured with the microphone. In addition, the acoustic channel analyzer 640 may determine a gain by the noise and a gain by the impulse on the basis of a prediction result and output the gain by the noise and the gain by the impulse as analysis parameters.

In operation 1240, a watermark encoder 650 may amplify the watermark according to the analysis parameters determined in operation 1230.

In operation 1250, the watermark encoder 650 may embed the watermark amplified in operation 1240 into the first audio signal output in operation 1210 to output the second audio signal.

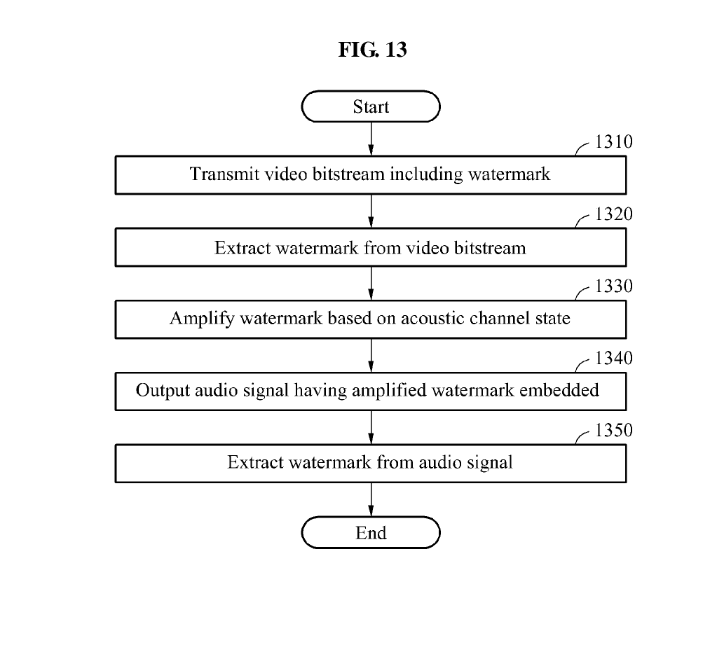

FIG. 13 is a flowchart illustrating a watermark transmission method according to a third embodiment of the present invention.

In operation 1310, a watermark embedding apparatus 110 may transmit a video bitstream including a watermark to a watermark transmission apparatus 100. In detail, the watermark embedding apparatus 110 may embed additional information as a watermark into original video information. The watermark embedding apparatus 110 may encode the video information with the embedded watermark to generate an audio bitstream and a video bitstream. Finally, the watermark embedding apparatus 110 may multiplex and transmit the audio bitstream and the video bitstream to the watermark transmission apparatus 100.

In operation 1320, the watermark transmission apparatus 100 may extract the watermark from the video stream received in operation 1310. In addition, the watermark transmission apparatus 100 may decode an audio signal from the audio bitstream received in operation 1310.

In operation 1330, the watermark transmission apparatus 100 may amplify the watermark extracted in operation 1320 based on a state of an acoustic channel.

In operation 1340, the watermark transmission apparatus 100 may embed the watermark amplified in operation 1330 into the audio signal decoded in operation 1320 to output the audio signal to a speaker.

In operation 1350, a terminal 120 may receive the audio signal output in operation 1340 using a microphone. The terminal 120 may extract the watermark from the received audio signal. That is, the watermark embedding apparatus 110 may embed the watermark into the video information to transmit an audio watermark to the terminal 120.

According to the present invention, a watermark is extracted from a received audio signal and the extracted watermark is amplified according to an acoustic channel state and embedded back into the audio signal, thereby minimizing errors by an acoustic channel distortion in a watermark transmitting process.

While the present invention has been described with reference to a few exemplary embodiments and the accompanying drawings, the present invention is not limited to the described exemplary embodiments. Instead, it would be appreciated by those skilled in the art that various modifications and variations can be made from the foregoing descriptions.

Therefore, it should be noted that the scope of the present invention is not limited by the illustrated embodiments but defined by the appended claims and their equivalents.

What is claimed is:

1. A method of transmitting a watermark, the method comprising:
extracting a watermark from a first audio signal comprising the watermark;
modifying the extracted watermark based on a state of an acoustic channel; and
embedding the modified watermark into the first audio signal to output a second audio signal.

2. The method of claim 1, further comprising determining an analysis parameter by analyzing the state of the acoustic signal measured with a microphone, wherein the modifying of the watermark amplifies the watermark based on the determined analysis parameter.

3. The method of claim 2, wherein the determining of the analysis parameter predicts a noise and an impulse generated by output of the second audio signal based on the measured state of the acoustic channel, and determines a gain by the noise and a gain by the impulse based on a prediction result.

4. The method of claim 2, wherein the state of the acoustic channel comprises at least one of a noise and an impulse generated by the second audio signal output at a previous time before measurement with the microphone.

5. A method of transmitting a watermark, the method comprising:
decoding a watermark and a first audio signal from a bitstream;
modifying the decoded watermark based on a state of an acoustic channel; and
embedding the modified watermark into the first audio signal to output a second audio signal.

6. The method of claim 5, further comprising determining an analysis parameter by analyzing the state of the acoustic signal measured with a microphone, wherein the modifying of the watermark amplifies the watermark based on the determined analysis parameter.

7. The method of claim 6, wherein the determining of the analysis parameter predicts a noise and an impulse generated by output of the second audio signal based on the measured state of the acoustic channel, and determines a gain by the noise and a gain by the impulse based on a prediction result.

8. The method of claim 6, wherein the state of the acoustic channel comprises at least one of noise information and impulse information generated as the second audio signal is output at a previous time.

9. The method of claim 5, wherein the bitstream is configured by comprising a watermark bitstream obtained by converting additional information into a bitstream in an ancillary area of an audio bitstream obtained by converting the first audio signal into a bitstream.

10. The method of claim 5, wherein the bitstream is configured by combining a watermark bitstream obtained by converting additional information into a bitstream with an audio bitstream obtained by converting the first audio signal into a bitstream as additional information.

11. A method of transmitting a watermark, the method comprising:
extracting a watermark from a video signal comprising the watermark;
modifying the extracted watermark based on a state of an acoustic channel; and
embedding the modified watermark into an audio signal related to the video signal to output the audio signal.
